(19) United States
(12) Patent Application Publication
(10) Pub. No.: US 2006/0032338 A1
(43) Pub. Date: Feb. 16, 2006

(54) Device for assisting the removal of automobile hubs

(76) Inventor: Douglas Glenn Perry, Plymouth, MI (US)

Correspondence Address: Theodore J. Lang, 8950 Ann Arbor Road, Plymouth, MI, 48170, US

(21) Appl. No.: 11/200,574

(22) Filed: Aug. 10, 2005

Related U.S. Application Data
(60) Provisional application No. 60/600,176, filed on Aug. 10, 2004.

(51) Int. Cl. B25B 13/50

(52) U.S. Cl. 81/53.2

(57) ABSTRACT

The invention is a tool that generally enables the application of force to a bolt end along the longitudinal axis of a bolt. In the embodiment described herein, the invention involves the servicing of automobile hub by providing a means for safely and effectively removing the hub stud bolts that have seized to the steering knuckle or other component to which it is mounted. The invention eliminates the realistic probability of damaging the hub stud bolts' threads, ensures that striking force can be applied without bending or breaking the hub stud bolts, and provides a surface suitable for applying a sufficient striking force to free a seized hub from a steering knuckle or other component to which it is mounted. The invention can be manufactured in a straightforward manner. In the disclosed embodiment, the invention provides for the safe and effective removal of a hub from a steering knuckle, through the use of the invention, that can reduce the labor time and material costs in hub servicing an automobile hub.

### CROSS-REFERENCE TO RELATED APPLICATIONS

This application is amended to claim the benefit of the provisional Application Number 60/600,176 under 35 U.S.C. 119(e).

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is a tool that improves the ability to apply longitudinal striking force to bolt end to remove it from a hold to which it is secured. In one embodiment of the invention, the tool facilitates the removal of an automobile hub from a steering knuckle that requires service. The removal of an automobile hub represents the need identified by the one embodiment of this tool, but the tool can be used for a plurality of applications.

The present embodiment of the invention tool pertains to the removal of an automobile hub from a steering knuckle. The removal of an automobile's hub is often required when service is performed on the hub assembly. This operation can be made difficult in cases where the hub has been assembled on an automobile for long periods without removal, particularly when the automobile is operated in a corrosive environment. This difficulty is caused mainly due to rust that forms as result of exposure to moist weather conditions and other elements of corrosion within the location of the hub area of an automobile.

The hub is typically bolted to a steering knuckle, as is the case on some four-wheel drive automobiles. The hub is held in place by stud bolts that are inserted through receiving holes within the steering knuckle with the hub stud bolts drawn tight with nuts on the opposite side of the steering knuckle. As this system is exposed to weather and other elements, the stud bolts and the holes receiving the stud bolts tend to rust causing the stud bolts to seize to the holes of the steering knuckle. The removal of the hub at this point often requires more force than can be applied by a service technician by hand, or more force than the service technician can apply to the hub by prying or hammering without damaging the hub's components.

The invention applies to the improved ability to apply longitudinal force on a bolt end to dislodge it from its anchoring. The embodiment disclosed herein to illustrate the features of the tool relates to the effective removal of automobile hubs that are secured to a steering knuckle with hub stud bolts.

In disclosing the present embodiment of the invention, the existing difficulties with removing the hub from a steering knuckle require a tool to improve upon the current approaches. The current approaches to removing a hub seized to a steering knuckle are inadequate.

One current approach to removing the hub involves applying a prying force on the outer edge of the hub with the nuts loosened and taken off the stud bolts. This approach may provide the force needed to remove the hub, but it can cause damage to hub and to surrounding components. In particular, force applied to the mounting flange can cause warping or chipping of the hub's outer edge.

Another approach to removing the hub involves applying a striking force with a hammer to the stud bolts behind the steering knuckle with the nuts loosened and taken off the hub stud bolts. Again this may enable the removal of the hub, but it can cause damage to the hub stud bolts by battering the their threads and possibly bending or breaking the hub stud bolts. As is often the case in servicing the hub, this damage requires the replacement of the hub stud bolts, which increases the time and material costs of the hub service. In an attempt to protect the stud bolt threads, mechanics often thread the loosened nuts onto the stud bolts and apply the striking force onto the nuts themselves. This can still lead to damage to the stud bolts and nuts because there is not enough surface area contact between the hub stud bolts' threads and the nuts' threads to prevent damage to the hub stud bolts from the striking force required to free the hub from the steering knuckle. Also, any deflection in the hammering action can bend or break the hub stub bolts.

The above current approaches to removing a hub seized to the steering knuckle do not provide an effective way to remove the hub from the steering knuckle. The same concern applies for a plurality of applications that require the use striking force along the longitudinal axis of a bolt to remove it from its anchoring without damage to the bolt. A tool is required which allows the application of longitudinal force to a bolt without damaging the bolt and its threads. In one particular embodiment, a tool is required to permit the removal of a hub from a steering knuckle without causing damage to the hub and its components.

### BRIEF SUMMARY OF THE INVENTION

The invention is a tool that allows, among a plurality of applications, the removal of an automobile hub easily and in a manner that prevent damage to the hub. The tool is threaded onto the hub stud bolts after the nuts have been removed to permit a damage-free application of striking force to be applied to effectuate the removal of a seized hub. The tool provides a surface with which to apply the striking force easily and effectively by a service technician to remove the hub from a steering knuckle when servicing certain automobiles.

### BRIEF DESCRIPTION OF THE DRAWINGS

FIG. 1 illustrates a three-dimensional perspective view showing the threaded end of the tool.

FIG. 2 illustrates a three-dimensional perspective view showing the battering end of the tool.

FIG. 3 illustrates a two-dimensional side view of the tool that shows the threaded end of the tool and the battering end of the tool.

FIG. 4 illustrates the application of the tool onto the hub stud bolts to allow the application of the striking force.

### DETAILED DESCRIPTION OF THE INVENTION

The invention is a tool that allows, among a plurality of applications, the removal of an automobile hub easily and in a manner that prevents damage to the hub. The operation of the tool involves the threading of the tool onto a hub stud bolt, with its anchoring nuts removed, and applying a striking force to the opposite end of the tool along the longitudinal axis of the hub stud bolt, thereby providing the means to free a hub stud bolt that is seized to a steering knuckle.

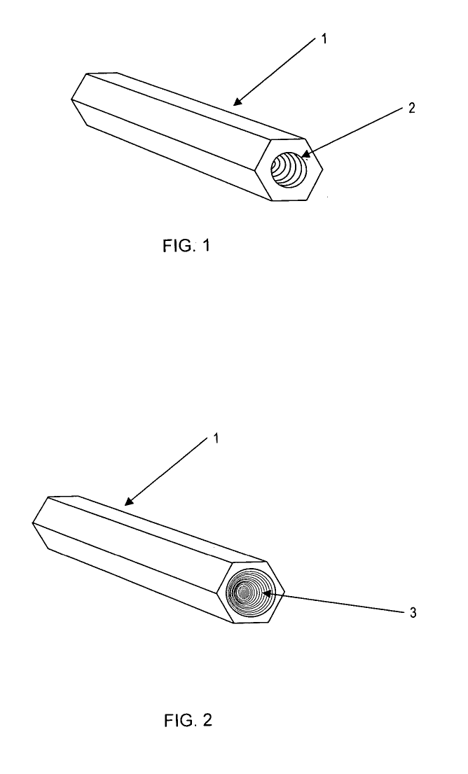

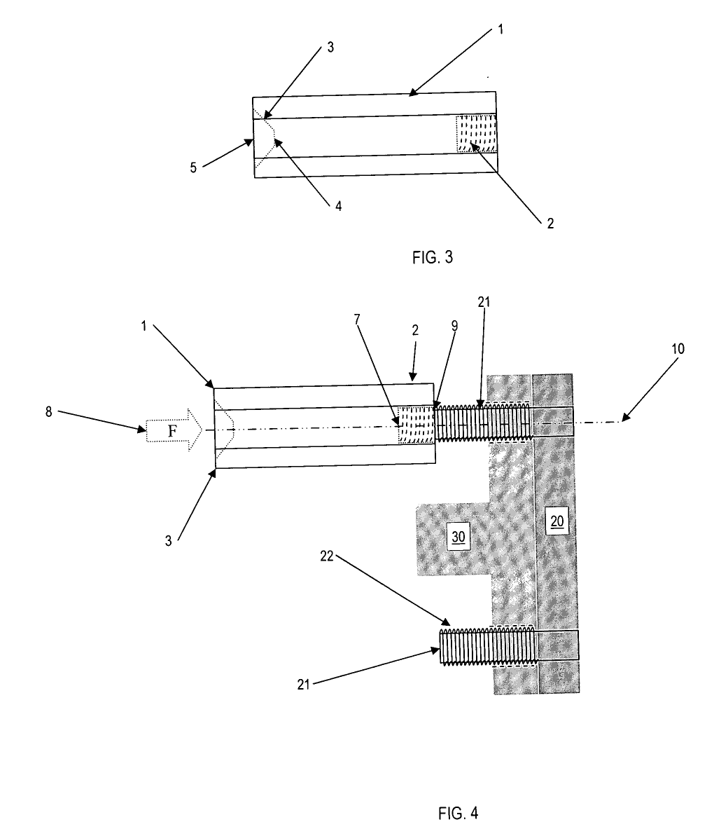

Referring to FIG. 1 and FIG. 3, the tool 1 is made of an ordinary stock of material 1, such as steel, of a suitable length. In one embodiment, the tool 1 can be made from hexagon-shape steel rod of a suitable dimension for the fabrication of the tool. Although the hexagon shape is not critical to the usefulness of the tool 1, the hexagon shape provides the ability to apply torque to the tool through the use of a wrench to effectively thread the tool 1 onto the hub stud bolt. The ability to thread the tool 1 onto a stud bolt effectively can be obtained by fabricating the tool from other shapes that allow for applying torque to the tool when threading it onto a stud bolt, such as through the use of pliers.

At one end, the tool 1 is threaded 2 to allow for the insertion of the hub stud bolt into the threaded end 2 of the tool 1. This is accomplished by threading the threaded end 2 onto the stud bolt, applying the necessary torque to the tool 1, and continuing the rotation of the tool 1 until the stud bolt bottoms out in the tool's threaded end 2. This bottoming out of the tool 1 onto the hub stud bolt provides the utility of the tool 1 of preventing damage to the stud bolt's threads by providing the necessary surface area contact between the tool's threads 2 and the threads of the stud bolt.

Referring to FIG. 2 and FIG. 3, the other end of the tool 1 is shaped 3 to receive the striking force of a hammer. In one embodiment of the invention, the tool's 1 battering end 5 has a conical shape 3 with a flat surface 4 at the bottom of the conical shape 3. This shape permits the use of a punch or other such instrument to be used in the striking action to help ensure that the striking force is aligned with the longitudinal axis of the hub stud bolt. The striking force can be applied with the use of a hammer directly upon the battering end 5 of the tool, also. Other shapes for the battering end 5 of the tool 1 can be incorporated that provide the same benefit so long as they provide the function of directing the striking force along the longitudinal axis of the stud bolt.

Referring to FIG. 4, the operation of the invention is demonstrated. The tool 1 is threaded 9 onto the hub 20 stud bolt 21. The number of rotations of the tool 1 onto the hub 20 stud bolt 21 must be sufficient to ensure that the threads of the hub 20 stud bolt 21 are not damaged from the striking force 8 applied to the battering end 3 of the tool 1. One method of ensuring that the number of rotations is sufficient is by threading the tool 1 onto the hub 20 stud bolt 21 until the hub 20 stud bolt 21 bottoms out 7 in the threaded end 2 of the tool 1. Again, the bottoming out of the tool 1 onto the hub 20 stud bolt 21, illustrated in this embodiment of the invention, demonstrates one of the key benefits of the tool 1 in preventing damage to the hub's 20 stud bolt 21 threads 22 by providing the necessary surface area contact between the tool's 1 threads 2 and the hub 20 stud bolt 21 threads 22. Other embodiments for ensuring sufficient surface contact between the tool's 1 threads 2 and the threads 22 of the hub's 20 stud bolt 21 generally require that the tool 1 stop at the point where sufficient surface area contact between the tool's 1 threads 2 and the hub 20 stud bolt 21 threads 22 is achieved, thereby providing a positive indication that enough rotations of the tool 1 has occurred.

Referring again to FIG. 4, after the tool 1 is properly threaded 9 with the threaded end 2 of the tool 1 bottomed out 7 onto the hub 20 stud bolt 21, a striking force 8, such as with a hammer, can be applied with sufficient force and repetition to free the hub 20 from the steering knuckle 30 or other component to which the hub 20 is bolted. The striking force 8 can be applied with a hammer, or similar device, by itself or in conjunction with a centering device, such as a punch. The use of a centering device, which assists the alignment of the striking force along the longitudinal axis 10 of the hub 20 stud bolt 21, is dependent on the space available in the environment surrounding the hub 20 for the particular automobile being serviced or in the surrounding environment in any other use of the tool 1.

With the use of the tool 1 described in the embodiment of the invention above, the removal of an automobile hub can be performed more safely and effectively than approaches that are currently available. The simplicity of the tool 1 allows for the straightforward fabrication of the invention. This straightforward fabrication exhibits a significant advantage over other existing tools that may exist for removing an automobile hub. The tool 1 provides the ability to apply torque, by the use of a wrench in the present embodiment, or the use of other tools that can achieve torque force, necessary to thread the tool 1 onto a hub 20 stud bolt 21. The tool 1 provides protection against bending or breaking of the hub 20 stud bolts 21 and provides protection of the hub 20 stud bolt 21 threads 22 by aligning the striking force 8 along the longitudinal axis of the hub 20 stud bolt 21. The tool also provides a suitable structure for applying a striking force to free the hub 20 from the steering knuckle 30 or other component to which the hub 20 is bolted.

What is claimed

1. A device that allows the application of longitudinal battering force upon a stud bolt permitting the easy removal of the stud bolt from its installation and in a manner that prevents damage to the stud bolt threads comprising:
a solid of suitable length providing for the application of torque with a tool;
said solid possessing a threaded end with an appropriate size allowing for the insertion of a stud bolt;
said solid possessing a battering end.

2. The device set forth in claim 1:
wherein the material of said solid is metal.

3. The device set forth in claim 2:
wherein the length of said solid is hexagon shaped suitable for applying torque with a wrench or similar tool to enable the threading of said solid onto a stud bolt.

4. The device set forth in claim 3:
wherein the battering of said hexagon shaped solid is machined out in a manner permitting the centering of a punching tool when battering force is applied.
